(19) United States
(12) Patent Application Publication
(10) Pub. No.: US 2019/0327796 A1
(43) Pub. Date: Oct. 24, 2019

(54) OVEN APPLIANCE AND A METHOD FOR OPERATING AN OVEN APPLIANCE FOR CUSTOMIZED COOKING OUTCOME

(71) Applicant: Haier US Appliance Solutions, Inc., Wilmington, DE (US)

(72) Inventors: Sabrina Marie Hannah, Louisville, KY (US); Christopher Nils Naber, Louisville, KY (US)

(21) Appl. No.: 15/960,621

(22) Filed: Apr. 24, 2018

(51) Int. Cl. H05B 6/68; F24C 7/08; F24C 15/32; H05B 6/64; A23L 5/10

(52) U.S. Cl. CPC H05B 6/687; F24C 7/088; F24C 15/325; A23V 2002/00; H05B 6/6452; H05B 6/6473; A23L 5/15; H05B 6/6435

(57) ABSTRACT

An oven appliance includes a controller configured to provide a first prompt and a second prompt. The first prompt and the second prompt each include a selectable range of values for a characteristic of a food item. A cooking cycle is initiated based on a first response to the first prompt and a second response to the second prompt. The cooking cycle includes activating at least one of a first heating element, a second heating element, and a convection fan based on the first response and the second response. Related methods are also provided.

### FIELD OF THE INVENTION

The subject matter of the present disclosure relates generally to an oven appliance and a method for operating an oven appliance.

### BACKGROUND OF THE INVENTION

Oven appliances generally include a cabinet that defines a cooking chamber for cooking food items therein, such as by baking or broiling the food items. To heat the cooking chamber for cooking, oven appliances include one or more heating elements positioned at a top portion, a bottom portion, or both, of the cooking chamber. Some oven appliances also include a convection heating element and fan for convection cooking cycles. The heating element or elements may be used for various cycles of the oven appliance, such as a preheat cycle, a cooking cycle, or a self-cleaning cycle.

During a typical cooking cycle, the air and surfaces of the cooking chamber are heated to a set temperature, creating a heating environment within the cooking chamber for cooking food items that is maintained during the cooking cycle, e.g., over one or more stages. The stages of the cooking cycle typically are performed for a set amount of time, e.g., a user-selected or predetermined amount of time. Typically, such oven cycles are predetermined component cycling routines that have been established to be generally acceptable for most items that may be cooked using that cycle. However, measuring the environmental or ambient temperature within the cooking chamber is only an indirect assessment of the food item or items being prepared within the cooking chamber. As such, cooking cycles based on oven air temperature and/or set amounts of time do not account for variations in food properties such as size, shape, initial temperature, etc., or other important variations such as altitude. Additionally, component cycling routines which are predetermined to accommodate a wide variety of food items may not produce the intended or optimal result for specific food items within the broad range of items for which such cycles are designed.

Accordingly, an oven appliance with features for controlling a cooking cycle within a cooking chamber of the oven appliance which is specific to the particular food item or items being cooked and based on a more direct assessment of the food item(s) would be desirable.

### BRIEF DESCRIPTION OF THE INVENTION

Aspects and advantages of the invention will be set forth in part in the following description, may be apparent from the description, or may be learned through practice of the invention.

In one exemplary embodiment, an oven appliance is provided. The oven appliance includes a user interface. The user interface includes a display and a user input device. A cooking chamber for receipt of food items for cooking is defined in a cabinet of the oven appliance. A first heating element and a second heating element are in thermal communication with the cooking chamber. The oven appliance also includes a convection fan. The oven appliance further includes a controller in operative communication with the user interface, the first heating element, the second heating element, and the convection fan. The controller is configured to provide a first prompt on the display. The first prompt includes a selectable range of values for a first characteristic of a food item. The controller is also configured to receive a first response to the first prompt from the user input device. The controller is further configured to provide a second prompt on the display after receiving the first response. The second prompt includes a selectable range of values for a second characteristic of the food item. The controller is configured to receive a second response to the second prompt from the user input device. Based on the first response and the second response, the controller is configured to initiate a cooking cycle which includes activating at least one of the first heating element, the second heating element, and the convection fan.

In another exemplary embodiment, a method of operating an oven appliance is provided. The method includes providing a first prompt including a selectable range of values for a first characteristic of a food item on a display of a user interface and receiving a first response to the first prompt from a user input device of the user interface. The method also includes providing a second prompt comprising a selectable range of values for a second characteristic of the food item on the display after receiving the first response and receiving a second response to the second prompt via the user input device. The method further includes initiating a cooking cycle based on the first response and the second response. The cooking cycle includes activating at least one of the first heating element, the second heating element, and the convection fan.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary oven appliance according to one or more embodiments of the present subject matter.

FIG. 2 is a cross-sectional view of the oven appliance of FIG. 1 taken along the 2-2 line of FIG. 1.

FIG. 3 provides a schematic view of a cooking utensil as may be used with oven appliances according to the present subject matter.

FIG. 4 provides a flowchart illustrating an exemplary method for operating an oven appliance according to the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. In the context of an angle or direction, such terms include values within ten degrees greater or less than the stated direction. For example, “generally vertical” includes directions within ten degrees of vertical in any direction, e.g., clockwise or counter-clockwise.

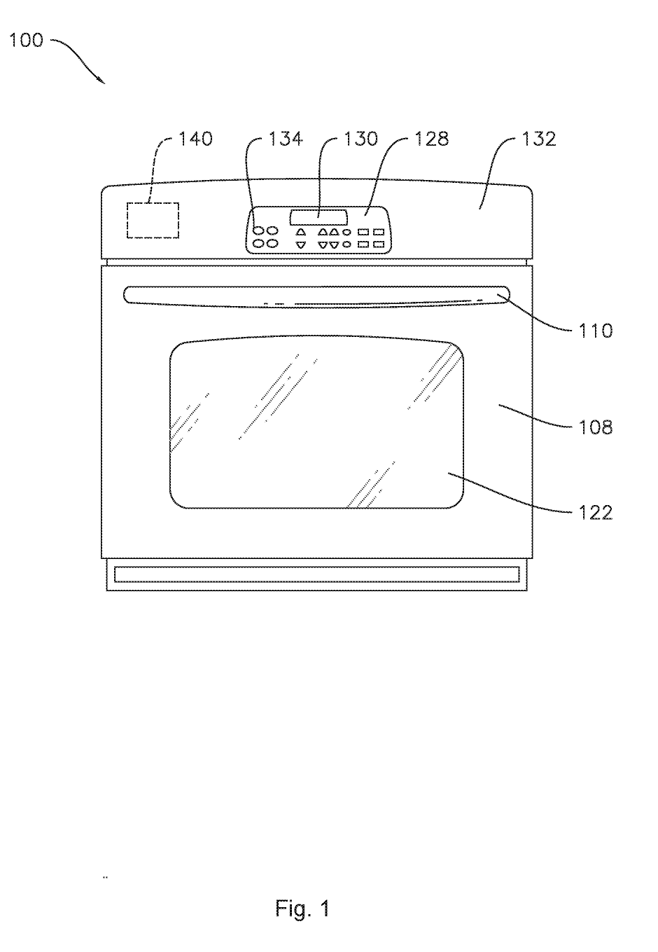

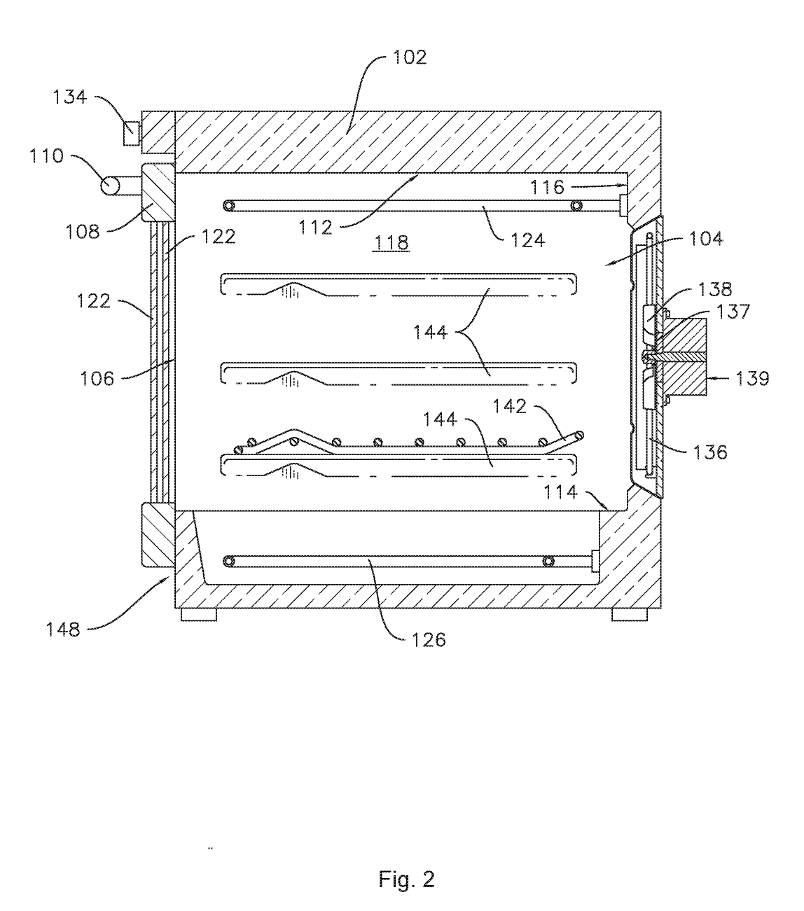

Referring to FIGS. 1 and 2, for this exemplary embodiment, oven appliance 100 includes an insulated cabinet 102 with an interior cooking chamber 104 defined by a top wall 112, a bottom wall 114, a back wall 116, and a pair of opposing side walls 118. Cooking chamber 104 is configured for the receipt of one or more food items to be cooked. Oven appliance 100 includes a door 108 pivotally mounted, e.g., with one or more hinges (not shown), to cabinet 102 at the opening 106 of cabinet 102 to permit selective access to cooking chamber 104 through opening 106. A handle 110 is mounted to door 108 and assists a user with opening and closing door 108. For example, a user can pull on handle 110 to open or close door 108 and access cooking chamber 104.

Oven appliance 100 can include a seal (not shown) between door 108 and cabinet 102 that assists with maintaining heat and cooking vapors within cooking chamber 104 when door 108 is closed as shown in FIGS. 1 and 2. Multiple parallel glass panes 122 provide for viewing the contents of cooking chamber 104 when door 108 is closed and assist with insulating cooking chamber 104. A baking rack 142 is positioned in cooking chamber 104 for the receipt of food items or utensils containing food items. Baking rack 142 is slidably received onto embossed ribs or sliding rails 144 such that rack 142 may be conveniently moved into and out of cooking chamber 104 when door 108 is open.

One or more heating elements may be provided at the top, bottom, or both of cooking chamber 104 provides heat to cooking chamber 104 for cooking. Such heating element(s) can be gas, electric, microwave, or a combination thereof. For example, in the embodiment shown in FIG. 2, oven appliance 100 includes a top heating element 124 and a bottom heating element 126, where bottom heating element 126 is positioned adjacent to and below bottom wall 114. Other configurations with or without wall 114 may be used as well.

Oven appliance 100 also has a convection heating element 136 and convection fan 138 positioned adjacent back wall 116 of cooking chamber 104. Convection fan 138 is powered by a convection fan motor 139. Further, convection fan 138 can be a variable speed fan—meaning the speed of fan 138 may be controlled or set anywhere between and including, e.g., zero and one hundred percent (0%-100%). In certain embodiments, oven appliance 100 may also include a bidirectional triode thyristor (not shown), i.e., a triode for alternating current (TRIAC), to regulate the operation of convection fan 138 such that the speed of fan 138 may be adjusted during operation of oven appliance 100. The speed of convection fan 138 can be determined by controller 140. In addition, a sensor 137 such as, e.g., a rotary encoder, a Hall effect sensor, or the like, may be included at the base of fan 138, for example, between fan 138 and motor 139 as shown in the exemplary embodiment of FIG. 2, to sense the speed of fan 138. The speed of fan 138 may be measured in, e.g., revolutions per minute (“RPM”). In some embodiments, the convection fan 138 may be configured to rotate in two directions, e.g., a first direction of rotation and a second direction of rotation opposing the first direction of rotation. For example, in some embodiments, reversing the direction of rotation, e.g., from the first direction to the second direction or vice versa, may still direct air from the back of the cavity. As another example, in some embodiments reversing the direction results in air being directed from the top and/or sides of the cavity rather than the back of the cavity.

In various embodiments, more than one convection heater, e.g., more than one convection heating elements 136 and/or convection fans 138, may be provided. In such embodiments, the number of convection fans and convection heaters may be the same or may differ, e.g., more than one convection heating element 136 may be associated with a single convection fan 138. Similarly, more than one top heating element 124 and/or more than one bottom heating element 126 may be provided in various combinations, e.g., one top heating element 124 with two or more bottom heating elements 126, two or more top heating elements 124 with no bottom heating element 126, etc.

Oven appliance 100 includes a user interface 128 having a display 130 positioned on an interface panel 132 and having a variety of user input devices, e.g., controls 134. Interface 128 allows the user to select various options for the operation of oven 100 including, e.g., various cooking and cleaning cycles. Operation of oven appliance 100 can be regulated by a controller 140 that is operatively coupled, i.e., in communication with, user interface 128, heating elements 124, 126, and other components of oven 100 as will be further described.

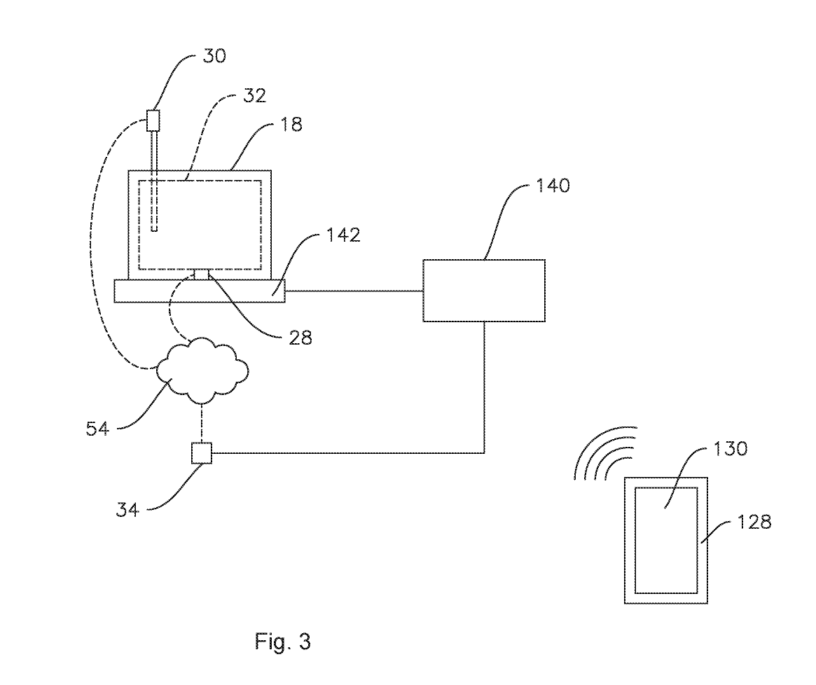

For example, in response to user manipulation of the user interface 128, controller 140 can operate the heating element(s). Controller 140 can receive measurements from one or more temperature sensors such as sensors 28 and 30 (FIG. 3) described below. Controller 140 may also provide information such as a status indicator, e.g., a temperature indication, to the user with display 130. Controller 140 can also be provided with other features as will be further described herein.

Controller 140 may include a memory and one or more processing devices such as microprocessors, CPUs, or the like, such as general or special purpose microprocessors operable to execute programming instructions or micro-control code associated with operation of oven appliance 100. The memory may represent random access memory such as DRAM or read only memory such as ROM or FLASH. In one embodiment, the processor executes programming instructions stored in memory. The memory may be a separate component from the processor or may be included onboard within the processor. The memory can store information accessible by the processor(s), including instructions that can be executed by processor(s). For example, the instructions can be software or any set of instructions that when executed by the processor(s), cause the processor(s) to perform operations. For the embodiment depicted, the instructions may include a software package configured to operate the system to, e.g., execute the exemplary methods described below. Controller 140 may also be or include the capabilities of either a proportional (P), proportional-integral (PI), or proportional-integral-derivative (PID) control for feedback-based control implemented with, e.g., temperature feedback from one or more sensors 28 and 30 (FIG. 3).

Controller 140 may be positioned in a variety of locations throughout oven appliance 100. In the illustrated embodiment, controller 140 is located next to user interface 128 within interface panel 132. In other embodiments, controller 140 may be located under or next to the user interface 128 otherwise within interface panel 132 or at any other appropriate location with respect to oven appliance 100. In the embodiment illustrated in FIG. 1, input/output (“I/O”) signals are routed between controller 140 and various operational components of oven appliance 100 such as heating elements 124, 126, 136, convection fan 138, controls 134, display 130, alarms, and/or other components as may be provided. In one embodiment, user interface 128 may represent a general purpose I/O (“GPIO”) device or functional block.

In the illustrated embodiments, the user input device is provided as touch type controls 134, however, it should be understood that controls 134 and the configuration of oven appliance 100 shown in FIG. 1 are illustrated by way of example only. For example, the user interface 128 may be provided as a touchscreen which provides both the display 130 and the controls 134. As further examples, the user interface 128 may include various input components, such as one or more of a variety of electrical, mechanical, or electro-mechanical input devices including rotary dials, push buttons, and touch pads. User interface 128 may include other display components, such as a digital or analog display device designed to provide operational feedback to a user. In some embodiments, user interface 128 may be in communication with controller 140 via one or more signal lines or shared communication busses. In other embodiments, the user interface 128 may be configured as an external computing device or remote user interface device, such as a smart phone, tablet, or other device capable of connecting to the controller 140. For example, as illustrated in FIG. 3, the remote user interface device may be a handheld user interface 128 with a display 130 thereon, e.g., a touchscreen display. The remote user device may connect to the controller 140 wirelessly using any suitable wireless connection, such as wireless radio, WI-FI®, BLUETOOTH®, ZIGBEE®, laser, infrared, and any other suitable device or interface. For example, in some embodiments, the remote user interface may be an application or “app” executed by a remote user interface device such as a smart phone or tablet. Signals generated in controller 140 may operate appliance 100 in response to user input via the user interface 128.

While oven 100 is shown as a wall oven, the present invention could also be used with other cooking appliances such as, e.g., a stand-alone oven, an oven with a stove-top, or other configurations of such ovens. Numerous variations in the oven configuration are possible within the scope of the present subject matter. For example, variations in the type and/or layout of the controls 134, as mentioned above, are possible. As another example, the oven appliance 100 may include multiple doors 108 instead of or in addition to the single door 108 illustrated. Such examples include a dual cavity oven, a French door oven, and others. The examples described herein are provided by way of illustration only and without limitation.

As shown in FIG. 3, a cooking utensil 18, depicted schematically, may be positioned on oven rack 142. One or more temperature sensors may be provided in the cooking chamber 104 and/or associated with the cooking utensil 18. Such sensors may measure a surface temperature of food items and/or a core temperature of food items which are cooking in the cooking chamber 104. As used therein, the “core temperature” of the food item includes any internal temperature, such as but not limited to a temperature measured at or near a center of the food item. For the example embodiment depicted, a cookware temperature sensor 28 configured for sensing the surface temperature of food item 32 (e.g., a temperature of a surface of the food item 32 which contacts the interior surface of the cooking utensil 18 where sensor 28 is embedded) and a food temperature sensor 30 configured for sensing the core temperature of the food item 32 are provided. In some example embodiments, the cookware temperature sensor 28 may be attached to or integrated into the cooking utensil 18. For example, the cookware temperature sensor 28 may be embedded within the bottom wall of the cooking utensil 18 as illustrated in FIG. 3. Alternatively, however, the cookware temperature sensor 28 may be attached to or integrated within a sidewall of the cooking utensil 18. The cookware temperature sensor 28 may be configured to sense a temperature of, e.g., a surface of the cooking utensil 18 and/or a surface of the food item 32 in contact therewith. Thus, in various embodiments, a directly measured temperature of the food item may be the sensed temperature of the cooking utensil only, the surface of the food item only, or both temperatures.

Additionally, the food temperature sensor 30 may be positioned at any suitable location to sense a temperature of one or more food items 32 (see FIG. 3) positioned within the cooking utensil 18. For example, the food temperature sensor 30 may be a probe type temperature sensor configured to be inserted into one or more food items 32. Alternatively, however, the food temperature sensor 30 may be configured to determine a temperature of one or more food items positioned within the cooking utensil 18 in any other suitable manner.

In certain exemplary embodiments, one or both of the cookware temperature sensor 28 and the food temperature sensor 30 may utilize any suitable technology for sensing/determining a temperature of the cooking utensil 18 and/or food items 32 positioned in the cooking utensil 18. For example, one or both of the cookware temperature sensor 28 and the food temperature sensor 30 may utilize one or more thermocouples, thermistors, optical temperature sensors, infrared temperature sensors, etc.

The oven appliance 100 may further include one or more receivers 34 configured to receive a signal from the food temperature sensor 30 and from the cookware temperature sensor 28. In at least some exemplary embodiments, one or both of the cookware temperature sensor 28 and the food temperature sensor 30 may include wireless transmitting capabilities, or alternatively may be hard-wired to the receiver 34 through a wired communications bus. For the embodiment depicted, the receiver 34 is configured as a wireless receiver 34 configured to receive one or more wireless signals. Specifically, for the exemplary system depicted, both of the cookware temperature sensor 28 and the food temperature sensor 30 are configured as wireless sensors in wireless communication with the wireless receiver 34 via a wireless communications network 54. In certain exemplary embodiments, the wireless communications network 54 may be a wireless sensor network (such as a BLUETOOTH® communication network), a wireless local area network (WLAN), a point-to point communication networks (such as radio frequency identification networks, near field communications networks, etc.), or a combination of two or more of the above communications networks. The receiver 34 may be operably connected to the controller 140 via a wired communication bus (as shown), or alternatively through a wireless communication network similar to the exemplary wireless communication network 54 discussed above.

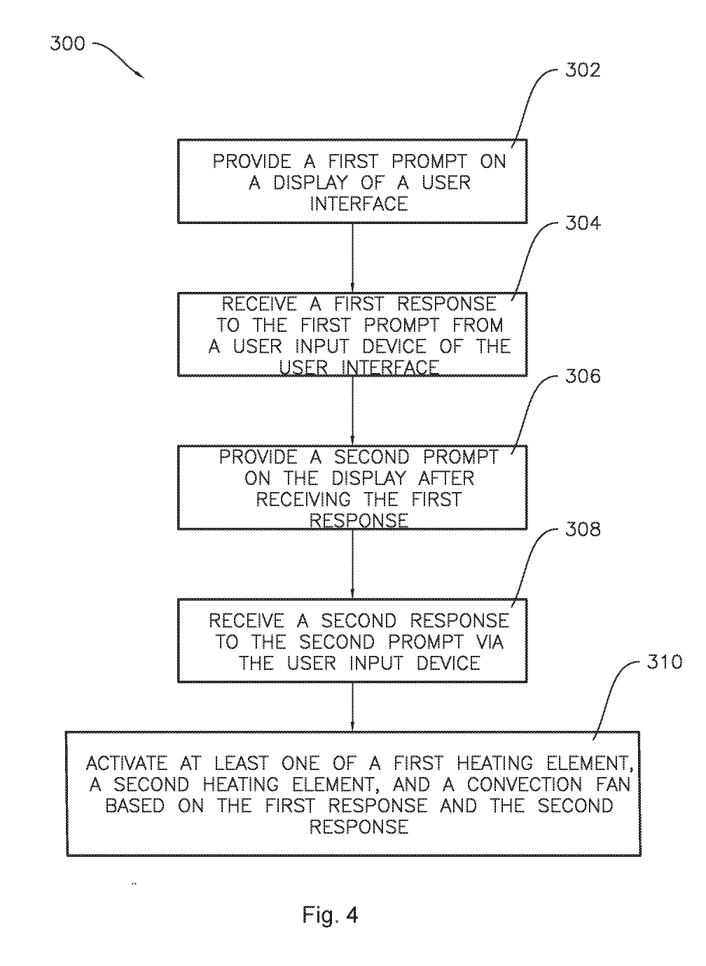

FIG. 4 illustrates an exemplary method 300 of operating oven appliance 100. Method 300 may be performed in whole or in part by controller 140 or any other suitable device or devices. At step 302, method 300 includes providing a first prompt on a display of a user interface, e.g., display 130 of user interface 128. At step 304 the exemplary method 300 includes receiving a first response to the first prompt. The first response may be received from a user input device, e.g., one of the controls 134, of the user interface 128. After receiving the first response, the method 300 may proceed to providing a second prompt on the display at step 306 and receiving a second response to the second prompt via the user input device.

In some embodiments, the method may also include a preliminary step of receiving an indication of a food item to be prepared. For example, a navigable menu may be displayed to a user on the user interface 128 to allow a user to select one of a plurality of types of food items from the menu. As another example, the user interface 128 may also or instead be configured for text input to permit a user to type in an indication of a food item to be prepared. In such embodiments, the first prompt may provide a selectable range of values for a first characteristic of the indicated food item and the second prompt provides a selectable range of values for a second characteristic of the indicated food item.

The first characteristic may be an internal characteristic of the indicated food item and the second characteristic may be an external characteristic of the indicated food item. For example, the indicated food item may be a baked good, such as a brownie or a cheesecake. In such examples, the internal characteristic may be an internal texture or density of the baked good, such as a range from “light” and/or “airy” to “dense” and/or “creamy” in the cheesecake example. Continuing the cheesecake example, the second characteristic in the second prompt may be an external characteristic such as surface appearance, which may range from “dark browning” to “no browning.” In the brownie example, the texture may be an internal texture, e.g., ranging from “light” and/or “cakey” to “dense” and/or “fudgy,” and the external characteristic may be an edge characteristic, e.g., ranging from “thick and chewy” to “just like the center.” As an additional example, the indicated food item may be a type of meat. In such embodiments, the first characteristic may be an internal characteristic such as center color, e.g., ranging from “pink” and/or “bloody” or “juicy” to “well done” and the second characteristic may be an external characteristic, e.g., ranging from “tender” to “seared.” Numerous other examples are also possible within the scope of the present subject matter where the first prompt and the second prompt provide specific options tailored to the particular food item indicated.

In some embodiments, the method may also include receiving an indication of other cooking variables. For example, such other cooking variables may include one or more of cookware type or starting temperature of the cooking chamber 104 before the cook cycle is initiated. For example, when the oven appliance 100 has recently been used, the starting temperature of the cooking chamber 104 may be significantly higher than in instances where the oven appliance 100 has not been used for a while.

Based on the first response and the second response, the method 300 may include initiating a cooking cycle, as shown at step 310 in FIG. 4. The cooking cycle generally includes activating at least one of the first heating element, the second heating element, and the convection fan based on the first response and the second response. For example, the first heating element may be a traditional or radiant heating element, such as heating element 126 described above. The second heating element may, in some exemplary embodiments, be a convection heating element such as convection element 136 described above, and the convection fan may be fan 138 as described above. The selection of which component or components to activate and the level, e.g., a power level of the first and/or second heating element or a speed of the convection fan, at which to activate the component(s) is selected based on both the first response and the second response. For example, in some embodiments, the power level may include electrical power supplied to a resistance heating element. As another example, in some embodiments the power level may also or instead include a flow rate of fuel suppled to a gas burner heating element. The specific combination of the first response and the second response may correspond to a unique set of operating parameters for the oven appliance 100.

Returning to the brownie example, the first heating element may be activated at a first power level when “dense and fudgy” internal texture is selected in response to the first prompt and “thick and chewy” edges are selected in response to the second prompt, while the first heating element may be activated at a second, different, power level when “dense and fudgy” internal texture is selected and edges “just like the center” is selected. Also by way of example, the second heating element may be activated when “dense and fudgy” internal texture is selected in combination with “thick and chewy” edges and the second heating element may not be activated when “light and cakey” internal texture is selected in combination with “thick and chewy” edges.

As a more generalized example, the first prompt may receive one of a range of responses, e.g., five possible responses such as options one through five. There may be a similar range of possible responses to the second prompt, e.g., five possible responses such as options A through E. In such embodiments, the oven appliance may activate selected components, e.g., one or more of the first heating element, the second heating element, and the convection fan, at a selected level or levels, e.g., power and/or speed, based upon the particular combination of the first response and the second response. For example, the oven appliance may operate with a first set of parameters based on a response of 1A, a second, different, set of parameters based on a response of 5A, yet another unique set of parameters based on a response of 5E, etc., where a unique set of operating parameters is provided for or corresponds to each possible combination of the first response and the second response. In other embodiments, one or both the ranges of possible responses may be less than five, e.g., at least two possible responses. In some embodiments, one or both of the ranges of possible responses may be greater than five, e.g., the first response and/or the second response may include a selection on a scale from zero to one hundred, such as a percentage.

Note that activating the first and/or second heating elements includes providing power to and operating the respective element or elements, e.g., as used herein “activating a heating element at a power level” generally includes a power level greater than zero. For example, the cooking cycle may include activating the first heating element at a power level and/or activating the convection fan at a speed. In such examples, the power level of the first heating element and the speed of the fan may be determined based on the first response and the second response. As another example, the cooking cycle may also or instead include activating the second heating element at a power level, and the power level at which the second heating element is activated may be determined based on the first response and the second response. For example, the cooking cycle may include alternately activating the first heating element and the second heating element each at full power or at varying power levels. In at least some embodiments, the cooking cycle may also or instead include simultaneously activating the first heating element and the second heating element during at least one stage of the cooking cycle.

In various embodiments, the cooking cycle may also include a preheat cycle or stage prior to a first stage or main stage of the cooking cycle. The preheat cycle may include activating a selected one or both of the first heating element and the second heating element at a power level. When both the first heating element and the second heating element are activated during the preheat cycle, the heating elements may be activated at the same power level or at differing power levels. The selection of the first heating element or the second heating element (or both) may be based on the first response and the second response, and the power level or levels may also be based on the first response and the second response. In some embodiments, the preheat cycle also include activating the convection fan at a speed, e.g., when the second heating element is selected. In such embodiments, the speed of the convection fan may be based on the first response and the second response.

In at least some embodiments, the cooking cycle may include a plurality of stages, e.g., a first stage (which may, as mentioned above, follow a preheat cycle) followed by at least one subsequent stage, e.g., a second stage, a third stage, and so on, as desired to produce an optimal outcome based on the combination or coordination of the first response and the second response. In embodiments where the cooking cycle comprises a plurality of stages, each stage of the cooking cycle may include modifying an operating parameter of at least one of the first heating element, the second heating element, and the convection fan based on the first response and the second response. For example, the cooking cycle may include activating the first heating element in a preheat cycle. In such embodiments, modifying an operating parameter of at least one of the first heating element, the second heating element, and the convection fan in the first stage may include modifying a power level of one or both of the first heating element and the second heating element. As another example, the first heating element may be activated at a first level, e.g., one hundred percent (100%) power, during a current stage of the cooking cycle, while the second heating element is deactivated and the convection fan is off. In this example, a subsequent cycle may include modifying any or all of the power level of the first heating element, the power level of the second heating element, and/or the speed or direction of the convection fan. The first stage will include modifying an operating parameter of at least one of the first heating element, the second heating element, and the convection fan in that all of the first heating element, the second heating element, and the convection fan will be deactivated prior to the first stage when no preheat cycle is included, and the first stage will include activating at least one of the first heating element, the second heating element, and the convection fan. In embodiments where a preheat cycle is included, the first stage may include modifying an operating parameter of at least one of the first heating element, the second heating element, and the convection fan relative to the operation of any one or all of such components during the preheat cycle.

In some embodiments, an exemplary method of operating an oven appliance and/or a cooking cycle of the oven appliance may include directly measuring a temperature of a food item, e.g., food item 32, as illustrated in FIG. 3, in the cooking chamber 104. In particular, in embodiments including a plurality of cooking stages, the plurality of stages may be performed sequentially and the cooking cycle may transition from a current stage of the plurality of stages to a subsequent stage of the plurality of stages based on the directly measured temperature of the food item. For example, the transition from one stage to the next may be based on the directly measured temperature reaching or exceeding a threshold temperature.

In various embodiments, the directly measured temperature may be any temperature of the food item 32 itself and/or a cooking utensil 18 in direct contact with the food item 32 as opposed to an indirect measurement of the food temperature, e.g., an ambient temperature of the air within the cooking chamber 104. For example, the controller 140 may be in operative communication with, and may receive a signal from, a temperature sensor, wherein the signal is representative of a directly measured temperature of the food item. In some embodiments, the temperature sensor may be a cookware temperature sensor configured for sensing the surface temperature of the food item and/or a surface of the cooking utensil 18 in direct contact with the food item, e.g., cookware temperature sensor 28 as described above. Additional embodiments of the surface temperature sensor may include an infrared temperature sensor, a laser temperature sensor, or any other suitable sensor configured for sensing the surface temperature of the food item. In some embodiments, a food temperature sensor configured for sensing the core temperature of the food item may be provided as well as or instead of the surface temperature sensor. For example, in various embodiments the controller 140 may be in operative communication with a temperature probe such as probe 30 as described above to directly measure a core temperature of a food item.

In various exemplary embodiments described herein throughout, the directly measured temperature may be measured continuously or repeatedly over a time interval, e.g., every second, every three seconds, or multiple times per second, etc. Accordingly, the directly measured temperature of the food item may be measured throughout the entire cooking cycle and various stages, e.g., as described above, may be implemented or performed in response to the directly measured temperature. For example, the stages of the cooking cycle or method may be delineated by temperature thresholds, in particular directly measured temperature thresholds, rather than predetermined time limits or ambient temperatures, as described above. Accordingly, in at least some embodiments, the exemplary methods described herein may provide an adaptive response to changes within the food item or items as the item(s) is/are cooking, where changes in surface temperature and/or core temperature such as reaching a threshold temperature may be indicative of temperature-based transitions in the food. Exemplary methods may also or instead provide an adaptive response to one or more of a rate of change in the directly measured temperature over time, a change in the rate of change in the directly measured temperature over time, the directly measured temperature meeting or exceeding a predetermined threshold, and/or the directly measured temperature meeting or exceeding the predetermined threshold for at least a predetermined amount of time. Such methods, e.g., cooking cycles, based on directly measured food temperature can provide a more specialized cooking outcome. Such methods may also provide an improved result relative to standard cycles due to consideration of temperature-based transitions in the food, such as protein structure changes, starch gelatinization, browning reactions, etc. When such transitions are reached, e.g., as indicated by a directly measured temperature of the food, the exemplary methods described herein may provide a responsive cooking operation by modifying one or more operating parameters of the oven appliance. In at least some embodiments, where the direct measurement of the food item temperature provides one or more of the above-described advantages as well as other advantages as will be apparent to those of skill in the art, methods according to the present subject matter may not include measuring an ambient temperature within the cooking chamber.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. An oven appliance, comprising:
a user interface comprising a display and a user input device,
a cabinet, the cabinet defining a cooking chamber configured for receipt of food items for cooking;
a first heating element in thermal communication with the cooking chamber;
a second heating element in thermal communication with the cooking chamber;
a convection fan;
a controller in operative communication with the user interface, the first heating element, the second heating element, and the convection fan, the controller configured to:
provide a first prompt on the display, the first prompt comprising a selectable range of values for a first characteristic of a food item;
receive a first response to the first prompt from the user input device;
provide a second prompt on the display after receiving the first response, the second prompt comprising a selectable range of values for a second characteristic of the food item;
receive a second response to the second prompt via the user input device; and
initiate a cooking cycle based on the first response and the second response, the cooking cycle comprising activating at least one of the first heating element, the second heating element, and the convection fan.

2. The oven appliance of claim 1, wherein the cooking cycle comprises a plurality of stages and each stage comprises modifying an operating parameter of at least one of the first heating element, the second heating element, and the convection fan based on the first response and the second response.

3. The oven appliance of claim 2, wherein the controller is in operative communication with at least one temperature sensor configured to directly measure a temperature of a food item in the cooking chamber and the controller is configured to perform the plurality of stages sequentially, wherein the controller transitions from a current stage of the plurality of stages of the cooking cycle to a subsequent stage of the plurality of stages of the cooking cycle based on the directly measured temperature of the food item.

4. The oven appliance of claim 1, wherein the cooking cycle comprises activating the first heating element at a power level and activating the convection fan at a speed, and wherein the power level of the first heating element and the speed of the fan are determined based on the first response and the second response.

5. The oven appliance of claim 1, wherein the cooking cycle comprises activating the second heating element at a power level, wherein the power level of the second heating element is determined based on the first response and the second response.

6. The oven appliance of claim 1, wherein the controller is further configured to receive an indication of a food item to be prepared, wherein the selectable range of values for the first characteristic in the first prompt is based on the indicated food item and the selectable range of values for the second characteristic in the second prompt is based on the indicated food item.

7. The oven appliance of claim 1, wherein the first characteristic is an internal characteristic of the food item and the second characteristic is an external characteristic of the food item.

8. The oven appliance of claim 1, wherein the user interface is positioned on the cabinet.

9. The oven appliance of claim 1, wherein the user interface is a user interface of a remote user device.

10. A method of operating an oven appliance, the method comprising:
providing a first prompt comprising a selectable range of values for a first characteristic of a food item on a display of a user interface;
receiving a first response to the first prompt from a user input device of the user interface;
providing a second prompt comprising a selectable range of values for a second characteristic of the food item on the display after receiving the first response;
receiving a second response to the second prompt via the user input device; and
initiating a cooking cycle based on the first response and the second response, the cooking cycle comprising activating at least one of the first heating element, the second heating element, and the convection fan.

11. The method of claim 10, wherein the cooking cycle comprises a plurality of stages and each stage comprises modifying an operating parameter of at least one of the first heating element, the second heating element, and the convection fan based on the first response and the second response.

12. The method of claim 11, further comprising directly measuring a temperature of a food item in a cooking chamber of the oven appliance and performing the plurality of stages sequentially, wherein the cooking cycle transitions from a current stage of the plurality of stages to a subsequent stage of the plurality of stages based on the directly measured temperature of the food item.

13. The method of claim 10, wherein the cooking cycle comprises activating the first heating element at a power level and activating the convection fan at a speed, and wherein the power level of the first heating element and the speed of the fan are determined based on the first response and the second response.

14. The method of claim 10, wherein the cooking cycle comprises activating the second heating element at a power level, wherein the power level of the second heating element is determined based on the first response and the second response.

15. The method of claim 10, further comprising a preheat cycle, the preheat cycle comprising activating a selected one of the first heating element and the second heating element at a power level, wherein the selection of the first heating element or the second heating element is based on the first response and the second response, and wherein the power level is based on the first response and the second response.

16. The method of claim 15, wherein the preheat cycle further comprises activating the convection fan at a speed when the second heating element is selected, the speed based on the first response and the second response.

17. The method of claim 10, further comprising receiving an indication of a food item to be prepared, wherein the selectable range of values for the first characteristic in the first prompt is based on the indicated food item and the selectable range of values for the second characteristic in the second prompt is based on the indicated food item.

18. The method of claim 10, wherein the first characteristic is an internal characteristic of the food item and the second characteristic is an external characteristic of the food item.
